(19) United States
(12) Patent Application Publication
(10) Pub. No.: US 2022/0128984 A1
(43) Pub. Date: Apr. 28, 2022

(54) MONITORING METHOD, MONITORING APPARATUS, AND PROGRAM

(71) Applicant: NEC Corporation, Minato-ku, Tokyo (JP)

(72) Inventor: Kiyoshi KATO, Tokyo (JP)

(73) Assignee: NEC Corporation, Minato-ku, Tokyo (JP)

(21) Appl. No.: 17/437,719

(22) PCT Filed: Feb. 26, 2020
(86) PCT No.: PCT/JP2020/007820

§ 371 Date: Sep. 9, 2021

(30) Foreign Application Priority Data
Mar. 19, 2019 (JP) 2019-051169

(51) Int. Cl. G05B 23/02

(52) U.S. Cl. CPC G05B 23/0221; G05B 23/0256; G05B 23/0224

(57) ABSTRACT

A monitoring apparatus according to the present invention includes: a control unit configured to confirm whether a measured value detected from a monitored object satisfies a preset condition, and execute processing for the monitored object set correspondingly to the condition in a case where the measured value satisfies the condition; and a recording processing unit configured to record an execution status of the processing for the monitored object into preset schedule data.

### TECHNICAL FIELD

The present invention relates to a monitoring method, a monitoring apparatus, and a program.

### BACKGROUND ART

In a plant such as a manufacturing factory or a processing facility, time-series data composed of observed values of elements that can be measured from various types of sensors is analyzed, and a change in the state of the plant such as occurrence of an anomalous state or occurrence of change in a manufacturing condition is detected. The measured values of the respective elements measured in the plant include, for example, temperature, pressure, flow rate, power consumption value, supply amount of raw material, remaining amount, and so on. As a method for detecting a change in the state of the plant, there is a method of previously generating a model representing the correlation of a plurality of time-series data, confirming whether newly observed time-series data keeps the correlation represented by the model and, when the correlation of the model is not maintained, detecting occurrence of an anomalous state. There is also a method of detecting occurrence of a certain state change simply when the time-series data does not satisfy a preset value condition.

A monitored object to detect the abovementioned state change is not limited to a plant, but may be equipment such as an information processing system. For example, in a case where the monitored object is an information processing system, the CPU (Central Processing Unit) usage rate, memory usage rate, disk access frequency, number of input/output packets, power consumption value, and so on, of information processing apparatuses configuring the information processing system are measured as the measured values of the respective elements, and these measured values are analyzed to detect a change in the state of the information processing system.

Then, when a change in the state of the monitored object is detected as described above, there may be a need to properly deal with the change in the state. For example, Patent Document 1 describes that when an anomalous state in the monitored object is detected, a preset action is executed in response to the detected anomalous state. As a specific example, a correlation model used for detecting the occurrence of the anomalous state in the monitored object is changed depending on the change in the state of the monitored object.
Patent Document 1: Japanese Patent Publication No. 5731223

However, by the abovementioned method, a set action is automatically executed when the anomalous state of the monitored object is detected, but a monitoring person who monitors the monitored object cannot recognize the execution of the action. Moreover, since the execution of the action depends on the change in the state such as the occurrence of the anomalous state, the monitoring person cannot recognize either the schedule of the end of the action or the schedule of the activation of the action. As a result, there arises a problem that an operation for the monitored object cannot be properly recognized.

### SUMMARY

Accordingly, an object of the present invention is to provide a monitoring method, a monitoring apparatus and a program that can solve the problem that an operation for a monitored object cannot be properly recognized.

A monitoring method according to an aspect of the present invention includes: confirming whether a measured value detected from a monitored object satisfies a preset condition; executing processing for the monitored object set correspondingly to the condition in a case where the measured value satisfies the condition; and recording an execution status of the processing for the monitored object into preset schedule data.

Further, a monitoring apparatus according to an aspect of the present invention includes: a control unit configured to confirm whether a measured value detected from a monitored object satisfies a preset condition, and execute processing for the monitored object set correspondingly to the condition in a case where the measured value satisfies the condition; and a recording processing unit configured to record an execution status of the processing for the monitored object into preset schedule data.

Further, in a non-transitory computer-readable storage medium according to an aspect of the present invention, a program is stored. The program includes instructions for causing an information processing apparatus to realize: a control unit configured to confirm whether a measured value detected from a monitored object satisfies a preset condition, and execute processing for the monitored object set correspondingly to the condition in a case where the measured value satisfies the condition; and a recording processing unit configured to record an execution status of the processing for the monitored object into preset schedule data.

With the configurations as described above, the present invention enables proper recognition of an operation for a monitored object.

### BRIEF DESCRIPTION OF DRAWINGS

FIG. 1 is a block diagram showing a configuration of a monitoring apparatus in a first example embodiment of the present invention;

FIG. 2 is a view showing a state of processing by the monitoring apparatus disclosed in FIG. 1;

FIG. 3 is a view showing a state of processing by the monitoring apparatus disclosed in FIG. 1;

FIG. 4 is a view showing a state of processing by the monitoring apparatus disclosed in FIG. 1;

FIG. 5 is a view showing a state of processing by the monitoring apparatus disclosed in FIG. 1;

FIG. 6 is a view showing a state of processing by the monitoring apparatus disclosed in FIG. 1;

FIG. 7 is a view showing a state of processing by the monitoring apparatus disclosed in FIG. 1;

FIG. 8 is a flowchart showing an operation of the monitoring apparatus disclosed in FIG. 1;

FIG. 9 is a flowchart showing an operation of the monitoring apparatus disclosed in FIG. 1;

FIG. 10 is a flowchart showing an operation of the monitoring apparatus disclosed in FIG. 1;

FIG. 11 is a flowchart showing an operation of the monitoring apparatus disclosed in FIG. 1;

FIG. 12 is a block diagram showing a hardware configuration of a monitoring apparatus in a second example embodiment of the present invention;

FIG. 13 is a block diagram showing a configuration of the monitoring apparatus in the second example embodiment of the present invention; and

FIG. 14 is a flowchart showing an operation of the monitoring apparatus in the second example embodiment of the present invention.

### EXAMPLE EMBODIMENTS

### First Example Embodiment

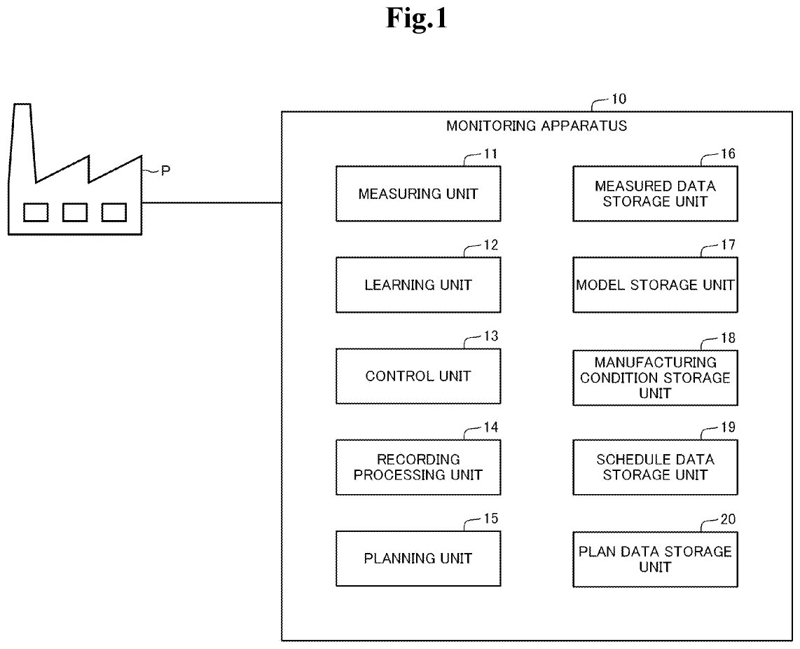

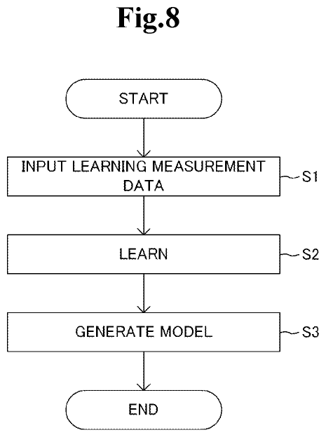

A first example embodiment of the present invention will be described with reference to FIGS. 1 to 11. FIGS. 1 to 7 are views for describing a configuration of a monitoring apparatus, and FIGS. 8 to 11 are views for describing a processing operation of the monitoring apparatus.

### [Configuration]

A monitoring apparatus 10 according to the present invention is connected to a monitored object P (an object) such as a plant. The monitoring apparatus 10 is used for acquisition and analysis of measured values of elements of the monitored object P and for monitoring of the state of the monitored object P based on the result of the analysis. For example, in this example embodiment, when a plant such as a manufacturing factory or a processing facility is the monitored object P, the monitoring apparatus 10 acquires, as the measured values of the respective elements, a plurality of kinds of information including not only sensor values such as temperature, pressure, flow rate, power consumption value, raw material supply amount, remaining amount, and component composition ratio value in the plant but also control values such as a pipe valve opening and production control numerical values such as production volume, cost, and quality inspection value. Then, the monitoring apparatus 10 monitors a change in a product manufacturing condition in the plant that is the monitored object P as a change in the state of the monitored object P, and executes processing according to the change in the state. The processing according to the change in the state is a process of detecting an anomalous state of the monitored object P operating under manufacturing conditions. Therefore, the monitoring apparatus 10 sets a correlation model of the elements corresponding to each of the manufacturing conditions and, by using the correlation model, calculates an anomaly degree from the measured value and outputs the anomaly degree, and detects and notifies an anomalous state.

In this example embodiment, the plant that is the monitored object P is configured to, when a certain measured value satisfies a set condition, thereby operate with a manufacturing condition (state) change. For example, the plant that is the monitored object P is configured to, in the case of operating under a manufacturing condition A for manufacturing a product A and satisfying a condition that the value of “temperature” that is an example of the measured value exceeds a set threshold value, change a product to manufacture to a product B and operate under a manufacturing condition B corresponding to the product B. Any condition may be set as a condition for the monitored object P to change a manufacturing condition. Moreover, the monitored object P may be configured so that, not limited to a manufacturing condition, some state of the monitored object P changes.

However, the monitored object P in the present invention is not limited to a plant, and may be a facility such as an information processing system, and the like. For example, in a case where the monitored object P is an information processing system, the monitoring apparatus 10 may monitor the state of the information processing system by measuring the CPU (Central Processing Unit) usage rate, memory usage rate, disk access frequency, number of input/output packets, power consumption value, and so on, of the information processing apparatuses configuring the information processing system, as the measured values of the respective elements, and analyzing the measured values.

The monitoring apparatus 10 includes one or a plurality of information processing apparatuses each including an arithmetic logic unit and a storage unit. Then, as shown in FIG. 1, the monitoring apparatus 10 includes a measuring unit 11, a learning unit 12, a control unit 13, a recording processing unit 14, and a planning unit 15, which are structured by execution of a program by the arithmetic logic unit. Moreover, the monitoring apparatus 10 includes a measured data storage unit 16, a model storage unit 17, a manufacturing condition storage unit 18, a schedule data storage unit 19, and a plan data storage unit 20, which are formed in the storage unit. The respective components will be described in detail below.

The measuring unit 11 acquires measured values of elements measured by various types of sensors installed in the monitored object P as time-series data at given time intervals, and stores the times-series data into the measured data storage unit 16. Since there are a plurality of kinds of elements to be measured, the measuring unit 11 acquires a time-series data set that is a set of time-series data of the plurality of elements. The acquisition and storage of the time-series data set by the measuring unit 11 is performed at all times and, as will be described later, the acquired time-series data set is used when generating a correlation model representing a normal state of the monitored object P and when monitoring the state of the monitored object P.

The learning unit 12 inputs a time-series data set measured when the monitored object P is determined to be in a normal state in advance, and generates a correlation model representing a correlation between elements in the normal state. For example, the correlation model includes a correlation function that represents a correlation between measured values of any two elements of a plurality of elements. The correlation function is a function that predicts the output value of the other element with respect to the input value of one element of any two elements. At this time, a weight is set in each of the correlation functions between the elements included in the correlation model. The learning unit 12 generates a set of correlation functions between a plurality of elements as described above as a correlation model, and stores the correlation model into the model storage unit 17.

In this example embodiment, the plant that is the monitored object P operates under a plurality of manufacturing conditions, and the learning unit 12 generates a correlation model that represents a normal state in a case where the monitored object P operates under each of the manufacturing conditions. For example, the plant that is the monitored object P is configured to operate under different manufacturing conditions A, B, and C when manufacturing products A, B, and C, respectively. Therefore, the learning unit generates a correlation model in a case where the monitored object P is in a normal state for each of the operating manufacturing conditions A, B, and C.

The control unit 13 acquires a time-series data set measured after generation of the abovementioned correlation model, analyzes the time-series data set, monitors whether the monitored object P is in a normal state or an anomalous state, and detects the occurrence of the anomalous state. To be specific, first, the control unit 13 detects a specific measured value from the monitored object P, and specifies a manufacturing condition under which the monitored object P is operating based on the specified measured value. Then, the control unit 13 sets a correlation model corresponding to the specified manufacturing condition, and detects the anomalous state of the monitored object P from a measured time-series data set by using the correlation model. For example, when “temperature” that is the specific measured value exceeds a set threshold value, the monitored object P in this example embodiment operates under “manufacturing condition B” for manufacturing a product B. Therefore, in a case where “temperature” that is the specific measured value exceeds the threshold value, the monitoring apparatus 10 specifies that the monitored object P is operating under “manufacturing condition B”, and sets a correlation model corresponding to “manufacturing condition B”. Then, the monitoring apparatus 10 monitors by using the correlation model corresponding to “manufacturing condition B” whether correlation breakdown is occurring in the time-series data set measured from the monitored object P operating under “manufacturing condition B”, and detects the occurrence of the anomalous state in the monitored object P in a case where correlation breakdown is occurring.

Thus, when a certain measured value satisfies a preset condition and it is thereby detected that the monitored object P operates under a specific manufacturing condition, the monitoring apparatus 10 starts a monitoring process corresponding to the specific manufacturing condition. Then, in a case where the certain measured value does not satisfy the present condition any more in a situation that the monitored object P is operating under the specific manufacturing condition, the monitoring apparatus 10 ends the monitoring process corresponding to the specific manufacturing condition. Alternatively, in a situation that the monitored object P is operating under a specific manufacturing condition, when a certain measured value satisfies a preset condition and it is thereby detected that the monitored object P operates under another manufacturing condition, the monitoring apparatus ends the monitoring process corresponding to the specific manufacturing condition in execution, and starts another monitoring process corresponding to the other new manufacturing condition.

As described above, the control unit 13 specifies a manufacturing condition under which the monitored object P operates based on a specific measured value. For each manufacturing condition, a corresponding condition of a specific measured value is preset, and stored into the manufacturing condition storage unit 18. That is to say, in the case of the above example, information that the monitored object P operates under “manufacturing condition B” when “temperature” exceeds a set threshold value is stored in the manufacturing condition storage unit 18, and the control unit 13 uses the information to specify a manufacturing condition under which the monitored object P operates from a specific measured value. A manufacturing condition is not limited to being specified from one specific measured value as described above, and may be specified from a plurality of specific measured values. For example, it is specified that the monitored object P is under a manufacturing condition B from, in addition to the measured temperature condition, a controlled raw material component ratio value and a quality confirmation value detected after production.

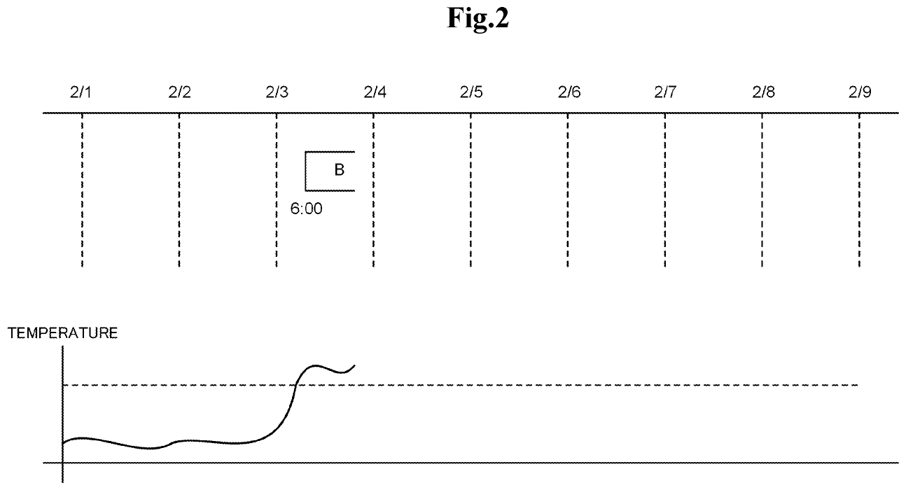

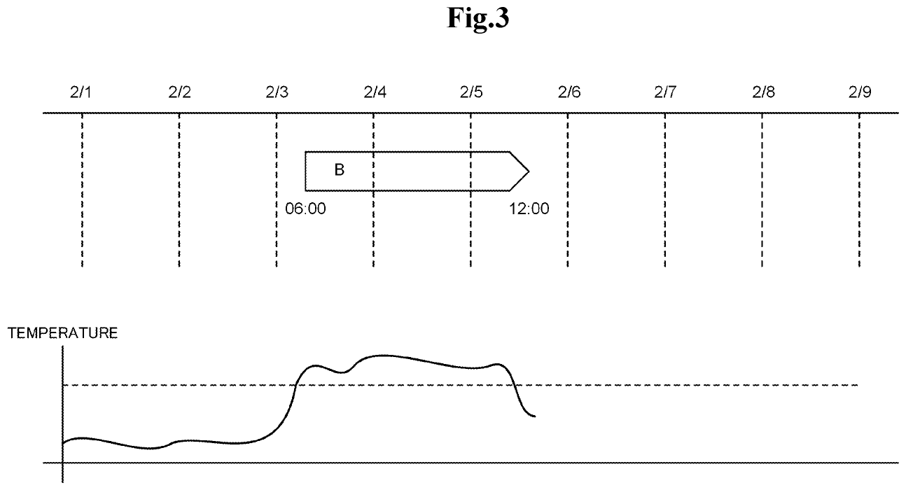

When the control unit 13 executes a monitoring process corresponding to a manufacturing condition under which the monitored object P is operating as described above, the recording processing unit 14 records the execution status of the monitoring process into schedule data stored in the schedule data storage unit 19. Here, the state of recording into the schedule data by the recording processing unit 14 will be described with reference to FIGS. 2 and 3. First, the schedule data stored in the schedule data storage unit 19 takes a time schedule on the horizontal axis as shown in the upper part of FIG. 2. Then, as shown in the lower part of FIG. 2, when “temperature” that is a specific measured value exceeds a threshold value (a dotted line) and the control unit 13 thereby starts a monitoring process corresponding to “manufacturing condition B”, the recording processing unit 14 associates the date and time when the monitoring process is started with the date and time set in the schedule data, and starts recording “execution status information B” representing that the monitoring process corresponding to “manufacturing condition B” is being executed into the schedule data. In the example of FIG. 2, the recording processing unit 14 displays the execution status information B by a band-shaped figure extending in the horizontal axis direction in accordance with the progress of the execution of the monitoring process, and records the execution status information B. At this time, as shown in FIG. 2, the recording processing unit 14 may indicate the start time of the monitoring process and record the execution status information B.

After that, as shown in the lower part of FIG. 3, when “temperature” that is the specific measured value becomes equal to or lower than the threshold value (the dotted line) and the monitoring process corresponding to “manufacturing condition B” by the control unit 13 ends, the recording processing unit 14 associates the date and time when the monitoring process ends with the date and time set in the schedule data, and ends recording of the execution status information B. In the example of FIG. 3, the recording processing unit 14 stops the length of the band-shaped figure extending in the horizontal axis direction in accordance with the progress of the execution of the monitoring process at the end time, and thereby ends recording of the execution status information B. At this time, as shown in FIG. 3, the recording processing unit 14 may indicate the end time of the monitoring process and record the execution status information B. However, the execution status information B may be any form of information, for example, may be composed of only character information.

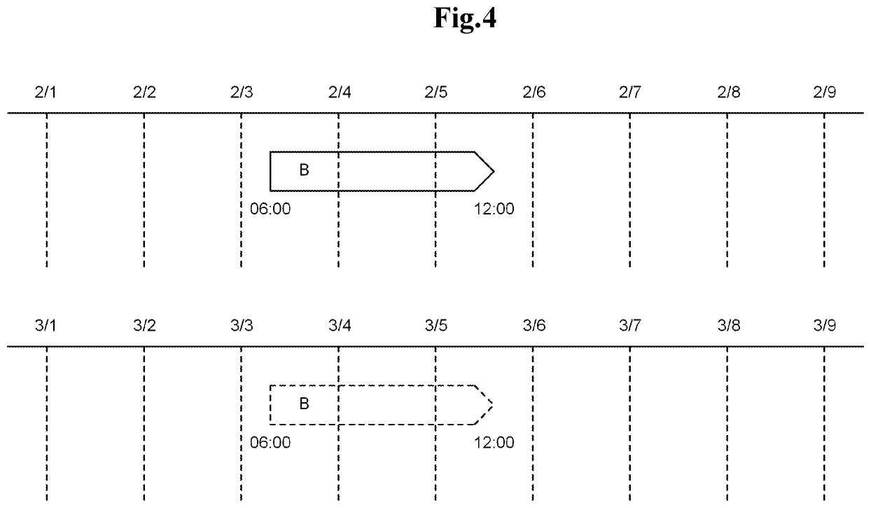

Further, the recording processing unit 14 predicts the date and time of execution of a monitoring process corresponding to the same manufacturing condition based on the execution status information recorded in the abovementioned manner, and records execution schedule information representing the predicted execution schedule of the monitoring process into the schedule data. For example, in the example of FIG. 4, as shown in the upper part, the recording processing unit 14 predicts based on “execution status information B” recorded from 6:00 on February 3 to 12:00 on February 5 in the schedule data that the same monitoring process will be executed at the same day and time of the next month, that is, from 6:00 on March 3 to 12:00 on March 5 and, as shown by the dotted line in the lower part of FIG. 4, associates “execution schedule information B” with the predicted date and time and stores into the schedule data. At this time, the recording processing unit 14 may predict execution schedule information by any method. For example, in a case where a monitoring process corresponding to the same manufacturing condition is executed a plurality of times and recorded in the schedule data, the recording processing unit 14 may predict the next execution date and time of the monitoring process based on the execution interval of the plurality of monitoring processes. Moreover, in a case where a certain monitoring process is executed at night on a specific day of the week, the recording processing unit 14 may predict that the monitoring process will be executed at night on the specific day of the week. Moreover, the recording processing unit 14 may predict in a manner that a time from the start to the end is different depending on hours based on the past processing results.

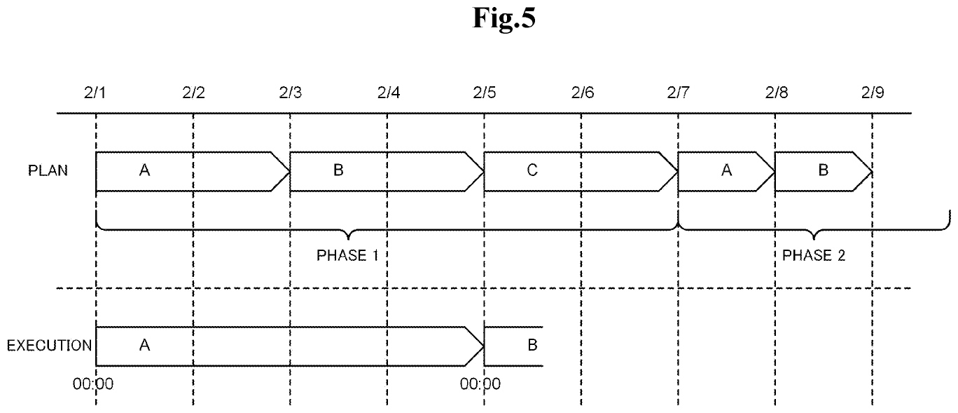

Further, the planning unit 15 has a function of modifying operation plan data preset for the monitored object P, based on the execution status information stored in the schedule data as described above. To be specific, first, operation plan data preset for the monitored object P is previously stored in the plan data storage unit 20. For example, as shown in the upper part of FIG. 5, it is planned that the monitored object operates under manufacturing conditions A, B, and C in this order two days for each, which is a phase 1, and operates under the manufacturing conditions A and B in this order one day for each, which is a phase 2. Execution status information is recorded in the schedule data for such operation plan data as shown in the lower part of FIG. 5. Herein, execution status information A of a monitoring process with respect to the manufacturing condition A is recorded first for four days, and then execution status information B of a monitoring process with respect to the manufacturing condition B is being recorded. In this case, the planning unit 15 can specify, from the recorded execution status information, an operation that the plant as the monitored object P has operated to manufacture a product A under the manufacturing condition A first for four days and then is operating to manufacture a product B under the manufacturing condition B.

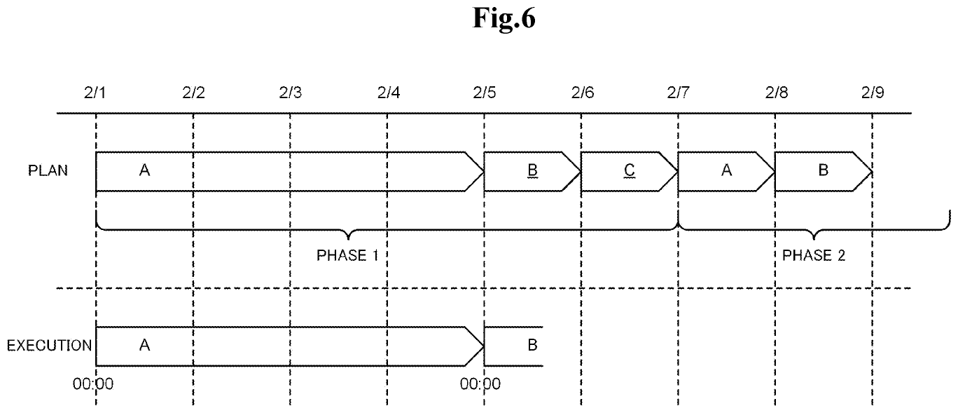

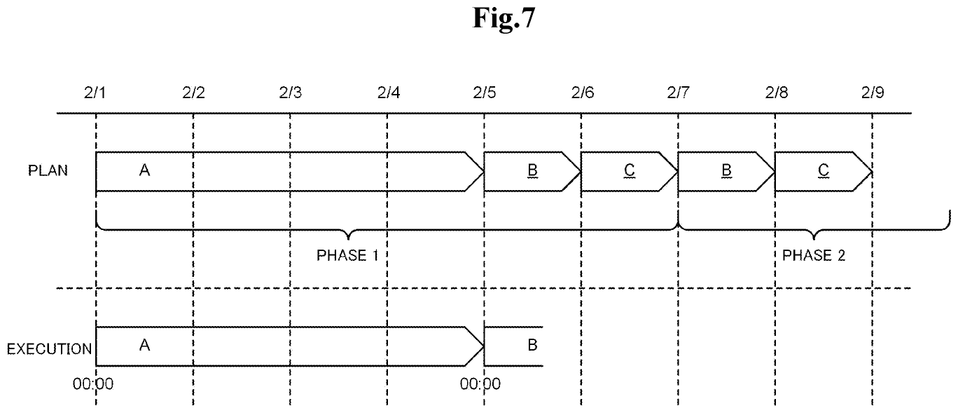

Then, the planning unit 15 compares the operation plan data with the actual operation of the plant, and modifies the operation plan data based on the comparison result. In the example of FIG. 5, comparing the operation plan data with the actual operation of the plant, it can be seen that a time to manufacture the product A under the manufacturing condition A is longer than that of the operation plan data and there is a possibility that a product C cannot be manufactured in the phase 1 if the operation plan data is as it is. Therefore, the planning unit 15 modifies the plan in the phase 1 of the operation plan data as shown in the upper part of FIG. 6. In this example, although the monitored object is scheduled to operate under the manufacturing condition C while the monitored object is currently operating under the manufacturing condition B, the planning unit 15 modifies the plan of the operation plan data so that the monitored object operates under the manufacturing conditions B and C in this order one day for each. Moreover, the planning unit 15 modifies the operation plan data in the phase 2 set thereafter. In this example, in the phase 2 before modification shown in the upper part of FIG. 6, the operation plan data is set so that the monitored object operates under the manufacturing conditions A and B in this order one day for each after the phase 1 ends. Then, as shown in the phase 2 of the upper part of FIG. 7, the operation plan data is modified so that the monitored object operates under the manufacturing conditions B and C in this order one day for each. The reason for thus modifying the operation plan data of the phase 2 is to supplement the manufacture volumes of products B and C in the phase 2 because times to operate in manufacturing processes B and C are short in the phase 1 and the manufacture volumes of the products B and C may be small. However, the planning unit 15 may modify the operation plan data of the monitored object P by any method.

### [Operation]

Next, an operation of the above monitoring apparatus 10 will be described mainly with reference to flowcharts of FIGS. 8 to 11. First, with reference to the flowchart of FIG. 8, an operation when generating a correlation model representing a correlation between elements in a state where the monitored object P is in a normal state will be described.

The monitoring apparatus 10 retrieves and inputs data for learning, which is a time-series data set measured when the monitored object P is operating under the operation condition A and the monitored object P is determined to be in the normal state, from the measured data storage unit 16 (step S1). Then, the monitoring apparatus 10 learns a correlation between elements from the input time-series data (step S2), and generates a correlation model representing the correlation between the elements (step S3). Then, the monitoring apparatus 10 stores the generated correlation model as a correlation model representing a normal state when the monitored object P is operating under the operation condition A into the model storage unit 17. The monitoring apparatus 10 thus generates a correlation model representing a normal state when the monitored object P is operating under the operation condition B, and a correlation model representing a normal state when the monitored object P is operating under the operation condition C, and if necessary, a correlation model when the monitored object P is operating under another operation condition, and stores the correlation models into the model storage unit 17.

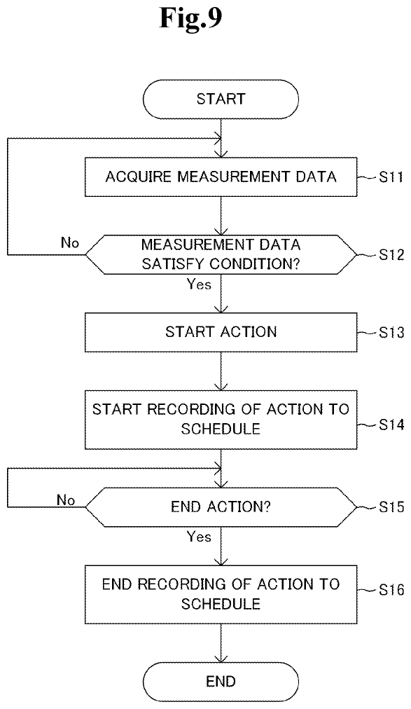

Next, with reference to the flowchart of FIG. 9, an operation when recording execution status information into schedule data will be described. The monitoring apparatus 10 acquires a specific measured value having been measured from the monitored object P (step S11), and confirms whether or not the measured value satisfies a certain condition stored in the manufacturing condition storage unit 18 (step S12). At this time, in a case where the specific measured value satisfies the certain condition (step S12, Yes), the monitoring apparatus 10 can specify that the monitored object P operates under a manufacturing condition set correspondingly to correspond to the certain condition, so that the monitoring apparatus 10 executes a monitoring process corresponding to the specified manufacturing condition (step S13). As an example, in a case where “temperature” that is a specific measured value satisfies a condition of exceeding a set threshold value, the monitoring apparatus 10 specifies that the monitored object P operates under “manufacturing condition B”, sets a correlation model corresponding to “manufacturing condition B”, and starts a monitoring process for the monitored object P using the correlation model. In FIG. 9, it is described as “action” that in a case where a specific measured value satisfies a certain condition, the monitored object P operates under a manufacturing condition set correspondly to the certain condition.

Upon starting execution of the monitoring process corresponding to the manufacturing condition under which the monitored object P is operating as descried above, the monitoring apparatus 10 starts recording of the execution status of the monitoring process into the schedule data stored in the schedule data storage unit 19 (step S14). For example, as shown in FIG. 2, when “temperature” that is a specific measured value exceeds a threshold value (a dotted line) and the monitoring apparatus 10 thereby starts a monitoring process corresponding to “manufacturing condition B”, the monitoring apparatus 10 starts recording of “execution status information B” representing that the monitoring process corresponding to “manufacturing condition B” is executed into the schedule data. At this time, the monitoring apparatus 10 starts recording of the execution status information B in a manner that the start date and time of the monitoring process is associated with the date and time set in the schedule data.

After that, as shown in FIG. 3, when “temperature” that is the specific measured value becomes equal to or less than the threshold value (dotted line) and the monitoring process corresponding to “manufacturing condition B” ends (step S15, Yes), the monitoring apparatus 10 ends recording of “execution status information B” into the schedule data (step S16). At this time, the monitoring apparatus 10 ends recording of the execution status information B so as to associate the date and time when the monitoring process ends with the date and time set in the schedule data.

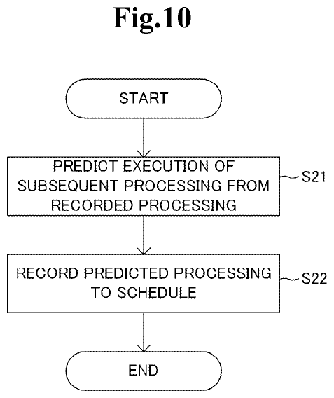

Next, with reference to the flowchart of FIG. 10, an operation when recording “execution schedule information” into schedule data will be described. The monitoring apparatus 10 predicts the date and time of execution of a monitoring process corresponding to the same manufacturing condition based on the execution status information recorded in the schedule data as described above (step S21). For example, as shown in FIG. 4, based on “execution status information B” recorded from 6:00 on February 3 to 12:00 on February 5 in the schedule data, the monitoring apparatus 10 predicts that the same monitoring process will be executed at the same day and time of the next month, that is, from 6:00 on March 3 to 12:00 on March 5. Then, the monitoring apparatus 10 associates “execution schedule information B” with the predicted date and time and stores into the schedule data (step S22).

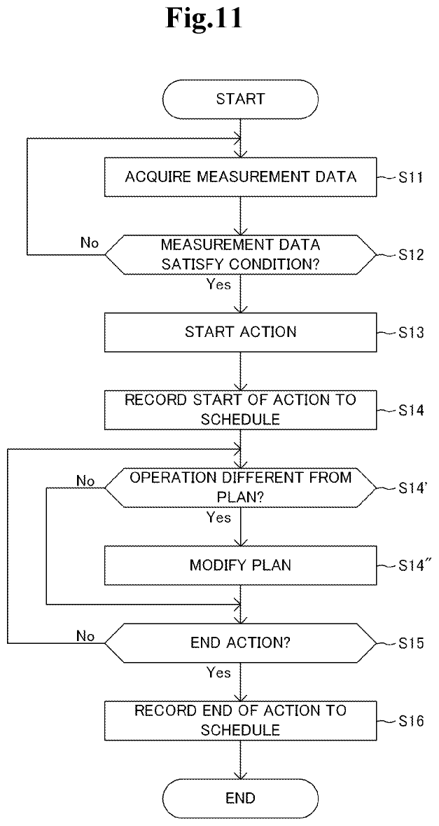

Next, with reference to the flowchart of FIG. 11, an operation when modifying operation plan data will be described. FIG. 11 is partly the same as FIG. 8. Moreover, it is assumed that as operation plan data, data of the content shown in the upper part of FIG. 5 is previously stored.

First, in the same manner as described above, the monitoring apparatus 10 acquires a specific measured value having been measured from the monitored object P (step S11) and, in a case where the specific measured value satisfies a certain condition (step S12, Yes), starts execution of a monitoring process set correspondingly to the certain condition (step S13). Along with this, the monitoring apparatus 10 starts recording of the execution status of a monitoring process into the schedule data (step S14). Here, it is assumed that, as shown in the lower part of FIG. 5, the monitoring apparatus 10 starts execution of a monitoring process corresponding to “manufacturing condition B” and starts recording of the execution status information B at 00:00 on February 5. It is assumed that a monitoring process corresponding to “manufacturing condition A” has been executed for four days before then.

Subsequently, the monitoring apparatus 10 specifies an operation of the plant that is the monitored object P from execution status information recorded in the schedule data. In the example shown in the lower part of FIG. 5, the monitoring apparatus 10 can specify that the monitored object P operates to manufacture the product A under the manufacturing condition A first for four days and then operates to manufacture the product B under the manufacturing condition B. Then, the monitoring apparatus 10 compares the stored operation plan data with the actual plant operation specified as described above (step S14′). Then, in the example of FIG. 5, it can be seen that an actual operation time to manufacture the product A under the manufacturing condition A is longer than that of the operation plan data, and the start date and time of the operation to manufacture the product B under the manufacturing condition B is behind that of the operation plan data, so that the actual operation differs from the operation plan data (step S14′, Yes). In this case, the monitoring apparatus 10 modifies the plan of the operation plan data (step S14″). For example, as shown in the upper part of FIG. 6, the monitoring apparatus 10 modifies the operation plan data to a plan in which the plant operates under the manufacturing conditions B and C in this order one day for each so that the product B and the product C can be manufactured within the remaining time of Phase 1.

Further, the monitoring apparatus 10 modifies the operation plan data in the phase 2 set after that (step S14″). For example, in the example of FIG. 6, the phase 2 of the operation plan data before modification is set so that the plant operates under the manufacturing conditions A and B in this order one day for each. The monitoring apparatus 10 modifies the operation plan data so that the plant operates under the manufacturing conditions B and C in this order one day for each as shown in the phase 2 of FIG. 7. After that, when the monitoring process corresponding to “manufacturing condition B” ends (step S15, Yes), the monitoring apparatus 10 ends recording of the execution status information B into the schedule data (step S16).

As described, according to the present invention, when processing for a monitored object is executed in accordance with a measured value detected from the monitored object, an execution status of the processing for the monitored object is recorded into preset schedule data. Therefore, an execution status of processing actually executed for a monitored object in accordance with a measured value can be recorded, and a monitoring person can properly recognize an operation on the monitored object. In particular, by recording an execution status as a schedule expressed by date and time, a monitoring person can properly recognize whether or not an operation on a monitored object goes as a plan and whether the plan needs to be changed, as schedule data. As a result, the monitoring person does not need to monitor an operation on a monitored object at all times on a screen or the like, which can reduce a load on the monitoring person and efficiently operate the monitored object.

Further, according to the present invention, from a recorded actual execution status of processing for a monitored object, subsequent execution of the processing is predicted and recorded, and a plan of execution by the monitored object is modified. Thus, a monitoring person can more properly recognize an operation on the monitored object, and can make the monitored object efficiently operate.

In the above description, in a case where a measured value measured from the monitored object P satisfies a preset condition, the monitoring apparatus 10 executes a monitoring process corresponding to a state of the monitored object P that changes with the measured value satisfying the condition. However, in a case where a measured value measured from the monitored object P satisfies a preset condition, the monitoring apparatus 10 according to the present invention may execute any processing, not limited to the abovementioned monitoring process. Along with this, an execution status of any processing executed as described above may be recorded into schedule data or predicted.

### Second Example Embodiment

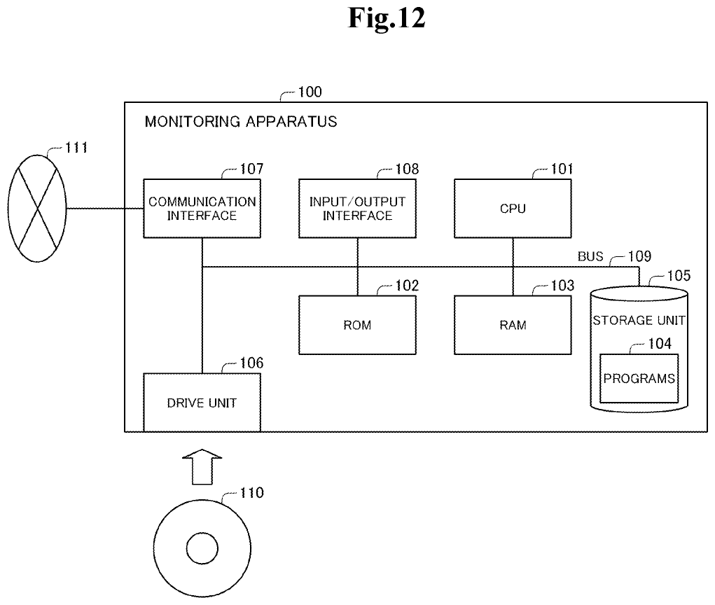

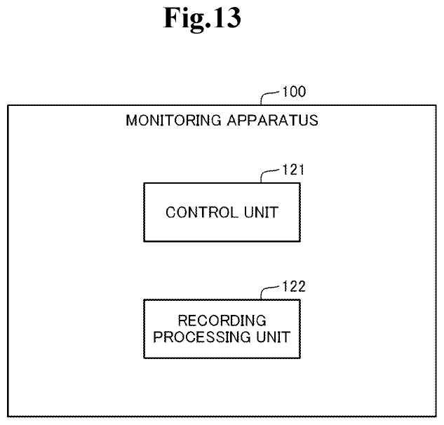

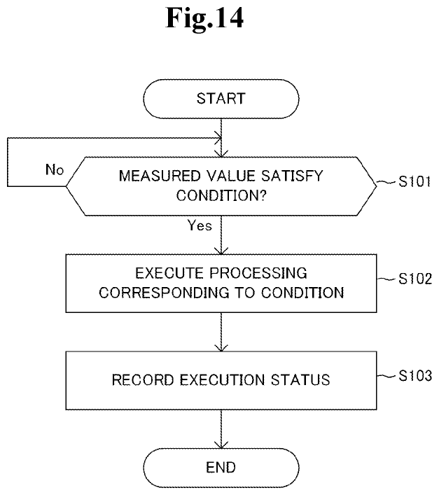

Next, a second example embodiment of the present invention will be described with reference to FIGS. 12 to 14. FIGS. 12 to 13 are block diagrams showing a configuration of a monitoring apparatus in the second example embodiment, and FIG. 14 is a flowchart showing an operation of the monitoring apparatus. In this example embodiment, the overview of configurations of a monitoring apparatus and a processing method by the monitoring apparatus will be illustrated.

First, with reference to FIG. 12, a hardware configuration of a monitoring apparatus 100 in this example embodiment will be described. The monitoring apparatus 100 is configured by a general information processing apparatus, and has the following hardware configuration as an example;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage unit 105 for storing the programs 104,

a drive unit 106 that reads from and writes into a storage medium 110 outside the information processing apparatus,

a communication interface 107 connecting to a communication network 111 outside the information processing apparatus,

an input/output interface 108 that inputs and outputs data, and

a bus 109 connecting the components.

Then, the monitoring apparatus 100 can structure and install a control unit 121 and a recording processing unit 122 shown in FIG. 13 therein by the CPU 101 acquiring and executing the programs 104. The programs 104 are, for example, previously stored in the storage unit 105 or the ROM 102, and loaded into the CPU 101 and executed by the CPU 101 as necessary. The programs 104 may be supplied to the CPU 101 via the communication network 111, or may be previously stored in the recording medium 110 and read and supplied to the CPU 101 by the drive unit 106. However, the control unit 121 and the recording processing unit 122 mentioned above may be structured by an electronic circuit.

FIG. 12 shows an example of the hardware configuration of the information processing apparatus that is the monitoring apparatus 100, and the hardware configuration of the information processing apparatus is not limited to the abovementioned case. For example, the information processing apparatus may be configured by part of the abovementioned configuration, for example, may be configured without the drive unit 106.

Then, the monitoring apparatus 100 executes a monitoring method shown in the flowchart of FIG. 14 by the functions of the control unit 121 and the recording processing unit 122 structured by the programs as described above.

As shown in FIG. 14, the monitoring apparatus 100:

confirms whether a measured value detected from a monitored object satisfies a preset condition (step S101);

in a case where the measured value satisfies the condition (step S101, Yes), executes processing for the monitored object set correspondingly to the condition (step S102); and

records an execution status of the processing for the monitored object into preset schedule data (step S103).

According to the present invention, with the configuration as described above, when processing for a monitored object is executed according to a measured value detected from the monitored object, an execution status of the processing for the monitored object is recorded into preset schedule data. With this, an execution status of processing actually executed for a monitored object according to a measured value can be recorded, and a monitoring person can properly recognize an operation on the monitored object.

The abovementioned program can be stored in various types of non-transitory computer-readable mediums and supplied to a computer. The non-transitory computer-readable mediums include various types of tangible storage mediums. The non-transitory computer-readable mediums include, for example, a magnetic recording medium (for example, a flexible disk, a magnetic tape, a hard disk drive), an optical magnetic recording medium (for example, an optical magnetic disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory)). Moreover, the program may be supplied to a computer by various types of transitory computer-readable mediums. The transitory computer-readable mediums include, for example, an electric signal, an optical signal, and an electromagnetic wave. The transitory computer-readable mediums can supply the program to a computer via a wired communication path such as an electric wire and an optical fiber or a wireless communication path.

Although the present invention has been described above with reference to the example embodiments and so on, the present invention is not limited to the above example embodiments. The configurations and details of the present invention can be changed in various manners that can be understood by one skilled in the art within the scope of the present invention.

The present invention is based upon and claims the benefit of priority from Japanese patent application No. 2019-051169, filed on Mar. 19, 2019, the disclosure of which is incorporated herein in its entirety by reference.

### <Supplementary Notes>

The whole or part of the example embodiments disclosed above can be described as the following supplementary notes. Below, the overview of the configurations of a monitoring method, a monitoring apparatus, and a program according to the present invention will be described. However, the present invention is not limited to the following configurations.

### (Supplementary Note 1)

A monitoring method comprising:

confirming whether a measured value detected from a monitored object satisfies a preset condition;

executing processing for the monitored object set correspondingly to the condition in a case where the measured value satisfies the condition; and

recording an execution status of the processing for the monitored object into preset schedule data.

### (Supplementary Note 2)

The monitoring method according to Supplementary Note 1, comprising recording the execution status into the schedule data correspondingly to date and time on and at which the processing for the monitored object is executed.

### (Supplementary Note 3)

The monitoring method according to Supplementary Note 1 or 2, comprising recording the execution status into the schedule data correspondingly to start time and end time of execution of the processing for the monitored object.

### (Supplementary Note 4)

The monitoring method according to any of Supplementary Notes 1 to 3, comprising, when execution of the processing for the monitored object is started, starting recording of the execution status into the schedule data correspondingly to start time at which the execution is started and, when the execution of the processing for the monitored object is ended, ending recording of the execution status into the schedule data correspondingly to end time at which the execution is ended.

### (Supplementary Note 5)

The monitoring method according to any of Supplementary Notes 1 to 4, comprising predicting subsequent execution of processing for the monitored object based on the execution status recorded in the schedule data, and recording information representing a schedule of the predicted execution of the processing for the monitored object into the schedule data.

### (Supplementary Note 6)

The monitoring method according to Supplementary Note 5, comprising predicting subsequent execution of processing for the monitored object based on date and time included in the execution status recorded in the schedule data, and recording information representing a schedule of the predicted execution of the processing for the monitored object into the schedule data.

### (Supplementary Note 7)

The monitoring method according to any of Supplementary Notes 1 to 6, comprising, in a case where an operation of the monitored object is different from a preset operation plan of the monitored object as a result of execution of the processing for the monitored object, modifying the operation plan based on the operation of the monitored object and the operation plan.

### (Supplementary Note 8)

The monitoring method according to Supplementary Note 7, comprising, in a case where an operation of the monitored object is different from the operation plan of present as a result of execution of the processing for the monitored object, modifying the operation plan separately set after the operation plan of present based on the operation of the monitored object, the operation plan of present and the operation plan separately set.

### (Supplementary Note 9)

A monitoring apparatus comprising:

a control unit configured to confirm whether a measured value detected from a monitored object satisfies a preset condition, and execute processing for the monitored object set correspondingly to the condition in a case where the measured value satisfies the condition; and

a recording processing unit configured to record an execution status of the processing for the monitored object into preset schedule data.

### (Supplementary Note 10)

The monitoring apparatus according to Supplementary Note 9, wherein the recording processing unit is configured to predict subsequent execution of processing for the monitored object based on the execution status recorded in the schedule data, and record information representing a schedule of the predicted execution of the processing for the monitored object into the schedule data.

### (Supplementary Note 11)

The monitoring apparatus according to Supplementary Note 9 or 10, comprising a planning unit configured to, in a case where an operation of the monitored object is different from a preset operation plan of the monitored object as a result of execution of the processing for the monitored object, modify the operation plan based on the operation of the monitored object and the operation plan.

### (Supplementary Note 12)

A non-transitory computer-readable storage medium in which a program is stored, the program comprising instructions for causing an information processing apparatus to realize:

a control unit configured to confirm whether a measured value detected from a monitored object satisfies a preset condition, and execute processing for the monitored object set correspondingly to the condition in a case where the measured value satisfies the condition; and

a recording processing unit configured to record an execution status of the processing for the monitored object into preset schedule data.

### (Supplementary Note 13)

The non-transitory computer-readable storage medium according to Supplementary Note 12, wherein the program comprises instructions for causing the information processing apparatus to further realize a planning unit configured to, in a case where an operation of the monitored object is different from a preset operation plan of the monitored object as a result of execution of the processing for the monitored object, modify the operation plan based on the operation of the monitored object and the operation plan.

### DESCRIPTION OF NUMERALS

10 monitoring apparatus
11 measuring unit
12 learning unit
13 control unit
14 recording processing unit
15 planning unit
16 measured data storage unit
17 model storage unit
18 manufacturing condition storage unit
19 schedule data storage unit
20 plan data storage unit
P monitored object
100 monitoring apparatus
101 CPU
102 ROM
103 RAM
104 programs
105 storage device
106 drive device
107 communication interface
108 input/output interface
109 bus
110 storage medium
111 communication network
121 control unit
122 recording processing unit

What is claimed is:

1. A monitoring method comprising:
confirming whether a measured value detected from a monitored object satisfies a preset condition;
executing processing for the monitored object set correspondingly to the condition in a case where the measured value satisfies the condition; and
recording an execution status of the processing for the monitored object into preset schedule data.

2. The monitoring method according to claim 1, comprising recording the execution status into the schedule data correspondingly to date and time on and at which the processing for the monitored object is executed.

3. The monitoring method according to claim 1, comprising recording the execution status into the schedule data correspondingly to start time and end time of execution of the processing for the monitored object.

4. The monitoring method according to claim 1, comprising, when execution of the processing for the monitored object is started, starting recording of the execution status into the schedule data correspondingly to start time at which the execution is started and, when the execution of the processing for the monitored object is ended, ending recording of the execution status into the schedule data correspondingly to end time at which the execution is ended.

5. The monitoring method according to claim 1, comprising predicting subsequent execution of processing for the monitored object based on the execution status recorded in the schedule data, and recording information representing a schedule of the predicted execution of the processing for the monitored object into the schedule data.

6. The monitoring method according to claim 5, comprising predicting subsequent execution of processing for the monitored object based on date and time included in the execution status recorded in the schedule data, and recording information representing a schedule of the predicted execution of the processing for the monitored object into the schedule data.

7. The monitoring method according to claim 1, comprising, in a case where an operation of the monitored object is different from a preset operation plan of the monitored object as a result of execution of the processing for the monitored object, modifying the operation plan based on the operation of the monitored object and the operation plan.

8. The monitoring method according to claim 7, comprising, in a case where an operation of the monitored object is different from the operation plan of present as a result of execution of the processing for the monitored object, modifying the operation plan separately set after the operation plan of present based on the operation of the monitored object, the operation plan of present and the operation plan separately set.

9. A monitoring apparatus comprising:
at least one memory configured to store instructions; and
at least one processor configured to execute instructions to:
confirm whether a measured value detected from a monitored object satisfies a preset condition;
execute processing for the monitored object set correspondingly to the condition in a case where the measured value satisfies the condition; and
record an execution status of the processing for the monitored object into preset schedule data.

10. The monitoring apparatus according to claim 9, wherein the at least one processor is configured to execute the instructions to:
predict subsequent execution of processing for the monitored object based on the execution status recorded in the schedule data, and record information representing a schedule of the predicted execution of the processing for the monitored object into the schedule data.

11. The monitoring apparatus according to claim 9, wherein the at least one processor is configured to execute the instructions to:
in a case where an operation of the monitored object is different from a preset operation plan of the monitored object as a result of execution of the processing for the monitored object, modify the operation plan based on the operation of the monitored object and the operation plan.

12. A non-transitory computer-readable storage medium in which a program is stored, the program comprising instructions for causing an information processing apparatus to execute processing to:
confirm whether a measured value detected from a monitored object satisfies a preset condition, and execute processing for the monitored object set correspondingly to the condition in a case where the measured value satisfies the condition; and
record an execution status of the processing for the monitored object into preset schedule data.
